(19) United States
(12) Patent Application Publication
(10) Pub. No.: US 2010/0128722 A1
(43) Pub. Date: May 27, 2010

(54) QUEUING MECHANISMS FOR LTE ACCESS AND SAE NETWORKS ENABLING END-TO-END IMS BASED PRIORITY SERVICE

(75) Inventors: Lila Madour, Kirkland (CA); Louis Segura, Saint-Laurent (CA); Paul J. Evans, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/626,665

(22) Filed: Nov. 26, 2009

Related U.S. Application Data
(60) Provisional application No. 61/118,259, filed on Nov. 26, 2008.
(60) Provisional application No. 61/185,010, filed on Jun. 8, 2009.

(51) Int. Cl. H04L 12/66; H04M 11/04

(52) U.S. Cl. 370/352; 379/45

(57) ABSTRACT

A system and method for queuing emergency telecommunication service requests prevent dropped connections by sending messages to nodes requesting the emergency telecommunication service that the request has been queued. This allows for an orderly queuing process and allows congestion related issues to be overcome without preempting existing network traffic.

### CROSS-REFERENCE TO RELATED APPLICATIONS

This application claims the benefit of priority from U.S. Provisional Patent Application No. 61/118,259 filed Nov. 26, 2008 entitled “Policy Management of Priority NGN (Next generation Networks) GETS (Government Emergency Telecommunications Service) IMS (IP Multimedia Subsystem) Sessions”, and from U.S. Provisional Patent Application No. 61/185,010 filed Jun. 8, 2009 entitled “SUPPORT OF QUEUING MECHANISM IN LTE ACCESS AND SAE CORE NETWORKS FOR AN END-TO-END IMS BASED PRIORITY SERVICE” the contents of both priority applications are expressly incorporated herein by reference.

### TECHNICAL FIELD

This invention relates generally to data flow management in Next Generation Networks (NGN) for preserving priority information.

### BACKGROUND

In emergency situations, such as natural disasters or terrorist attacks, telephony services become essential to the role of first responders. The ability of a first responder to access mobile networks is paramount to the ability to communicate effectively with large groups of people in order to provide a properly coordinated response.

There are two aspects to offering reliable service in such an event. The first is ensuring that there are sufficient resources to allow the responders to utilize the access network. After connecting to the access network, the second issue is ensuring that there are sufficient resources to allow access to the required application. The present invention will address issues related to the second of these problems.

One skilled in the art will appreciate that these issues revolve around the access to Next Generation Network (NGN) enabled with Government Emergency Telecommunications Services (GETS). Because these NGNs typically employ a data-packet based topography, as opposed to the conventional circuit switched telephony network topography, they rely on data services such as IP Multimedia Subsystems (IMS). IMS services are typically established through the use of the Session Initiation Protocol (SIP) between two nodes in a network.

In a conventional system, a user activates GETS functionality by placing a call to a defined number, and after connecting to that service identifies himself using a PIN. At this point the network should provide priority service to the connection. In a conventional circuit switched network, as long as the user is able to obtain a dialtone, the resources needed to place a call are reserved. In an NGN network, it is conceivable that in an emergency situation a user could obtain access to the network and through the network issue a connection request to the application providing GETS services, but that the application would not be able to connect to the user due to congestion on the NGN. This occurs because until the user is authenticated by the application, the connection to the user is not provided with sufficient priority to ensure a connection. Furthermore, queuing of requests at various points between the application and user equipment (UE) can result in lost priority connections if the queuing node does not properly respond to the sender on behalf of the as yet unreached user. In essence, if a node queues requests without keeping the connection to the source node active, the resources dedicated to the connection can be lost.

One source of the above problem is there is no end-to-end signaling support in NGN and LTE that will allow a predictable outcome of a SIP session establishment when queuing within the access resources (radio bearers) is required due to temporary congestion or overload in the evolved-UTRAN Node B (eNB). In addition queuing mechanisms in LTE access are currently not supported.

It is, therefore, desirable to provide a mechanism for ensuring proper handling of requests involving queuing between the application and the UE.

### SUMMARY

It is an object of the present invention to obviate or mitigate at least one disadvantage of the prior art.

In a first aspect of the present invention, there is provided a method of queuing emergency telecommunication service requests in a packet based telephony network node. The method comprises the steps of receiving an indication that resources required for a requested emergency telecommunication service are not presently available; queuing the request; reserving available resources for the requested service; and issuing a notification to the node from which the service request was received that queuing has been undertaken.

In an embodiment of the first aspect of the present invention, the packet based telephony network node is an evolved-UTRAN node B (eNB). Optionally the step of receiving can include determining that user equipment cannot be reached due to network congestion. In another embodiment, the method can include the step of initializing a timer, and optionally cancelling the reservation of the available resources upon expiry of the timer. In another embodiment, the step of initiating the requested service upon acquiring sufficient reserved available resources.

In a further embodiment of the first aspect, the requested service includes a request for a plurality of services. In another embodiment, the received indication indicates that sufficient resources are available for one of the requested plurality of services. Optionally the method can further include the step of initializing one of the requested plurality of services using the available resources and wherein the step of queuing includes queuing the services in the plurality of services not initialized. In another embodiment, the method includes initializing a timer and upon expiry of the timer dropping queued services in the plurality of services not initialized.

In alternate embodiments, the node can be a mobility management entity (MME) and the step of receiving can include receiving a message from an eNB that the service request has been queued. In another embodiment, the node is a signaling gateway (SGW) and the step of receiving includes receiving a message from a mobility management entity that the service request has been queued. In a further embodiment the node is a policy and charging rule function (PCRF) and the step of receiving includes receiving a message from a SGW that the service request has been queued. In another embodiment, the node is a Proxy Call Session Control Function and the step of receiving includes receiving a message from a PCRF that the service request has been queued.

In a second aspect of the present invention, there is provided a node for use in a packet based telephony network. The node comprises a resource availability engine, a request interface, a processor and a messaging interface. The resource availability engine determines the availability of network resources. The request interface receives a request for emergency telecommunication services. The processor is operatively connected to the resource availability engine and the request interface to determine, in accordance with the engine and the request interface, that a requested service should be queued. The messaging interface sends a message to the node from which a request for emergency telecommunication services is received indicating that the request has been queued upon determination by the processor.

In an embodiment of the second aspect of the present invention, the node is an evolved-UTRAN Node B (eNB), and optionally the resource availability engine determines that resources are unavailable by receiving an indication of lack of resources from another node. In another embodiment, the node is a mobility management entity (MME) and the resource availability engine determines that resources are unavailable by receiving an indication of lack of resources from an eNB. In a further embodiment, the node is a signaling Gateway (SGW) and the resource availability engine determines that resources are unavailable by receiving an indication of lack of resources from an MME. In a further embodiment, the node is a proxy call session control function (P-CSCF) and the resource availability engine determines that resources are unavailable by receiving an indication of lack of resources from a policy and charging function.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a dataflow involving queuing in an originating eNB (All bearer requests are queued): Network Initiated Resource Reservation;

FIG. 2 illustrates a dataflow involving queuing in an originating eNB (All bearer requests are queued): UE Initiated Resource Reservation;

FIG. 3 illustrates a dataflow involving queuing in originating eNB (partial successful resource reservation): UE Initiated Resource Reservation;

FIG. 4 illustrates a dataflow showing UE Initiated Resource Reservation, network indicates different queuing requirement per media; and

FIG. 5 illustrates a dataflow showing queuing in terminating eNB (All bearer requests are queued): UE Initiated Resource Reservation.

### DETAILED DESCRIPTION

The subject matter is directed to allowing the establishment and management of priority for NGN GETS requests in a congested NGN network.

The innovative teachings of the present invention will be described with particular reference to various exemplary uses and aspects of the preferred embodiment. However, it should be understood that this embodiment provides only a few examples of the many advantageous uses of the innovative teachings of the invention. Some statements may apply to some inventive features but not to others. Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the present invention, IP Multimedia Subsystem (IMS) mechanisms are employed to provide a queuing mechanism in LTE and NGN networks. When a node determines that congestion will require queuing, messages are sent to other nodes that will be impacted by the delay in establishing a session to ensure that the resources allocated to the session establishment are reserved. This prevents the connection from failing as a result of queuing. Along with the use of IMS mechanism referred to above, an improved receive interface to the P-CSCF (the interface between then Proxy Call Session Control Function (P-CSCF) and the Policy and Charging Rules Function (PCRF)) that allow the use of queuing mechanisms will also be introduced.

In situations where emergency telecommunications services are required, there is typically a high volume of traffic on the network. An emergency situation will often result in the network users connecting to the network to reach friends and family. This network usage results in congestion. Although a radio carrier can be established to a base station, and signaling channels may be obtainable, the resources required to allow a user to connect to the application may not be available. Although pre-emption of existing traffic offers a solution it is not preferred. Queuing the prioritized traffic will often allow the connection to be formed in a very short period as resources that become available are reserved for the queued session. As mentioned above, queuing can cause significant disruption if careful end-to-end considerations are not contemplated.

Queuing for the next available access network resources in eNB and gateway (GW) resources in the IMS user plane control nodes, such as MGCF, MRFC and IBCF is currently not specified in 3GPP standards. Queuing may be needed in the IMS call control nodes as well such as P/S/I-CSCF, BGCF, IBCF. In the alternative, the the capacity and characteristics of those nodes should be engineered so as to handle the priority requests (buffer size, priority processing based on the DSCP marking at the interface and RPH marking at the application).

SIP preconditions can be used. The originating user equipment (UE) and the terminating UE can agree to suspend the session establishment and not alert the terminating UE until the resources are reserved in either both sending and receiving segments or at least in the sending segment.

If a request for a resource is queued in the terminating side, a queuing notification (i.e., SIP 182 message) can be sent to the originator to inform the user/UE that the request is queued to avoid session timeout that may lead to unnecessary queued requests and undesirable outcomes.

If a request for a resource is queued in the originating side following a provisional answer from the terminating side, a queuing notification is sent to the terminating side under certain preconditions status. In one embodiment, a maximum queuing time can be established (e.g. 90 seconds). Ideally, the decision on the queue time would be based on simulation, analysis, or test bed results determined as a function of the system as implemented.

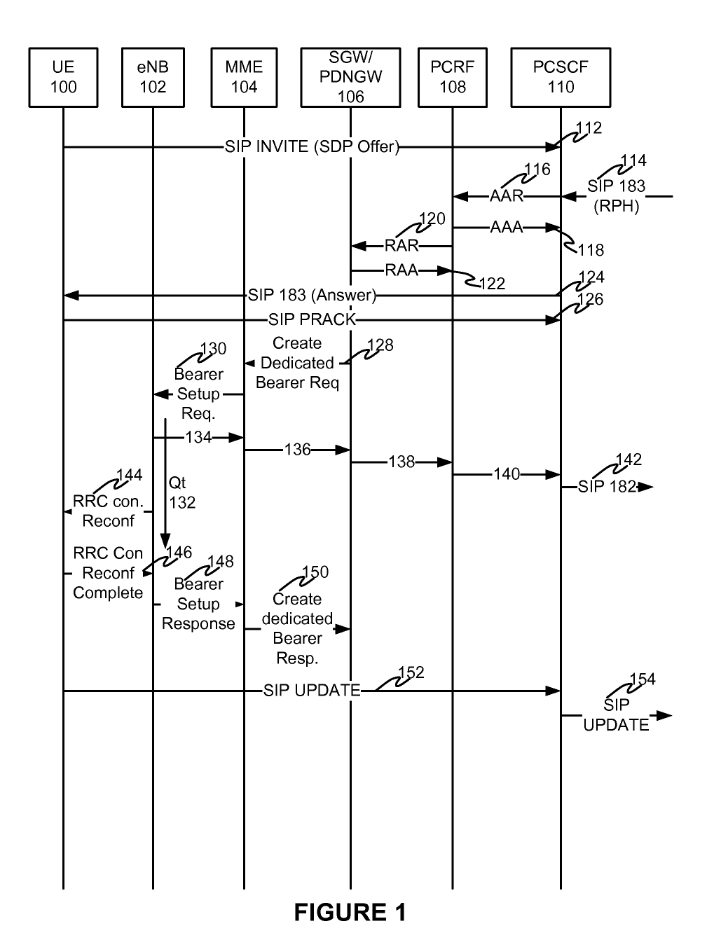

FIG. 1 illustrates a signal flow between nodes where queuing at the originating eNB results in a network initiated resource reservation. The UE 100 issues a session description protocol (SDP) offer to proxy Call Session Control Function (P-CSCF) 110 contained in SIP INVITE 112. After this transmission, UE 100 will only send an UPDATE towards the terminating end until all local resources are successfully established. In this scenario, the application requires reservation of two dedicated GBR bearers, and network initiated reservation is used. However, there are no available radio resource bearers in the eNB 102. The eNB 102 is able to queue the dedicated bearer resource requests from the Mobility Management Entity (MME) 104 if a queuing indication is included in the bearer request messages. The queuing indicator can be embedded in the ARP information element.

When the P-CSCF 110 receives SIP 183 114 from the application in response to the SIP INVITE 112, the SIP 183 will include the preconditions answer as well as the resource priority header (RPH) with ets and wps namespace, the later carries the user priority level in its rvalue as authorized by the application. The P-CSCF 110 interacts with the PCRF 108 sending AA Request 116. The PCRF sends an acknowledgement 118 back to the P-CSCF. A Re-Authentication Request 120 can be sent to the signaling Gateway/Packet Data network Gateway 106, which would then reply with a ReAuthentication Ansswer (RAA) 122. P-CSCF 110 forwards the SIP 183 message 124 to the UE 100. The UE 100 sends a SIP PRACK 126 back and waits for the network to setup the resources. Because this is a Network Initiated Reservation model, the UE 100 will not initiate a NAS Bearer Resource Allocation Request.

Meanwhile, the PCRF 108 performs the QoS mapping and interacts with the PDN GW 106 over Gx interface for resource reservation. The PCRF 108 includes the PCC rules which include the QoS information (ARP, QCI, GBR, MBR) to modify or create one or more dedicated Guaranteed Bit Rate (GBR) bearers. The ARP would include the queuing indicator if the application and/or the user subscription indicate that such priority mechanism should be applied in the event of congestion.

The PDN GW 106 initiates procedure for setting up dedicated GBR bearer(s). When the eNB 102 receives the bearer setup request(s) or reservation request, such as the bearer setup request 130 from MME 104 caused by the Create Dedicated Bearer Request message 128 from signaling gateway (SGW) 106, for that UE 100, it determines that there are no available radio bearer available at this time, and determines from the ARP priority level and queuing indicator that the received request(s) for that UE 100 should be queued for the next available radio bearer resources. The eNB puts 102 the request(s) in a queue, starts a queue timer (Qt) 132 and notifies the MME 104 that the bearer requests are queued using a bearer setup notification message 134.

The MME 104 forwards the queuing status to the SGW/PDN-GW 106 using message 136, and the PDN-GW 106 determines from the action triggers received from the PCRF 108 that it should notify the PCRF 108 if resource requests are queued. It sends the event trigger notification message 138 to the PCRF 108, and the PCRF 108 sends the notification 140 back to the application (P-CSCF 110). The P-CSCF 110 determines from the preconditions that the terminating user is waiting for resources to be setup in the originating side, thus initiates a SIP 182 message 142 back through the IMS chain to the terminating user.

Before Qt 132 expires, resources are freed and eNB 102 resumes the radio bearer resource setup procedure. An RRC con reconfiguration message 144 is sent to the UE 100, which replies with message 146 indicating that the reconfiguration is complete. The bearer setup response 148 is then sent to MME 104, which informs SGW 106 using message 150. Following successful establishment of all the queued GBR bearers requests, the UE 100 sends a SIP UPDATE message 152 to the P-CSCF 110. The P-CSCF 110 stops sending SIP 182 message and forwards the SIP UPDATE message 154 towards the terminating user via the IMS chain. The terminating user is alerted and a SIP 180 is sent to the originating user (not shown).

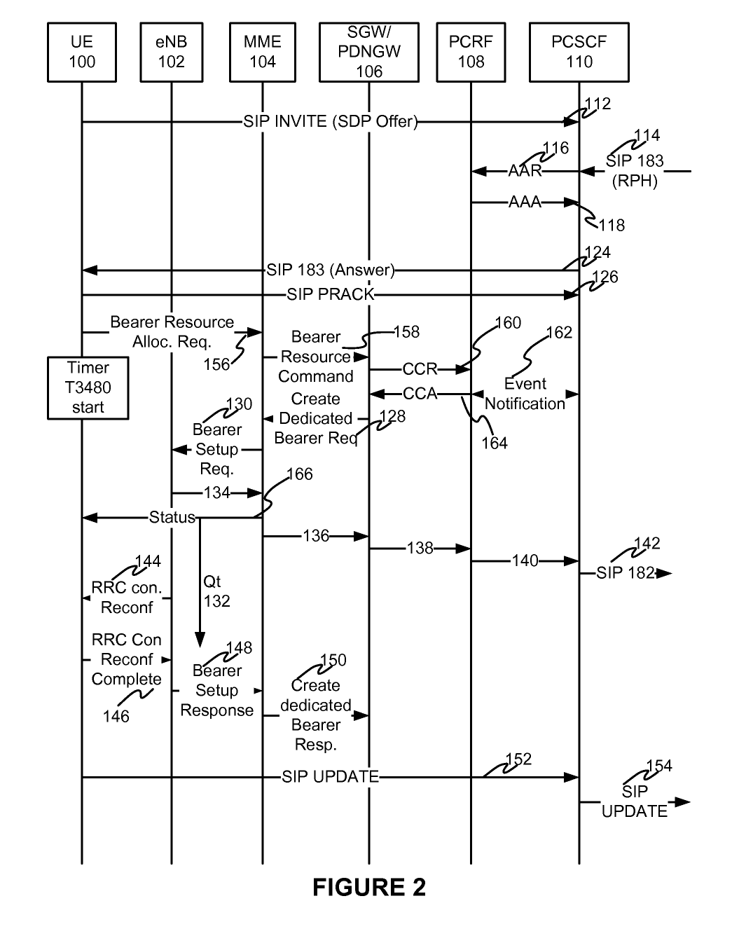

FIG. 2 illustrates signal flow between nodes where queuing is initiated at the eNB and all bearer requests are queued. One skilled in the art will appreciate that many of the same signals are sent as were sent in FIG. 1. The UE 100 include in the SDP Offer 112 two media lines (voice and video), with mandatory local precondition for both media. The UE 100 will only send an UPDATE towards the terminating end until all local resources are successfully established.

Same conditions as in the call flow of FIG. 1 except that a UE 100 initiates resource reservation procedure when it receives the SIP 183 containing the preconditions answer.

When the P-CSCF 110 receives SIP 183 message 114 in response to the SIP INVITE message 112, the SIP 183 message 114 will include the preconditions answer as well as the RPH with ets and wps namespace, the later carries the user priority level in its rvalue as authorized by the application.

The P-CSCF 110 interacts with the PCRF 108 using message 116. The PCRF 108 sends an acknowledgement 118 back to the P-CSCF 110 and the P-CSCF 110 forwards the SIP 183 message 124 to the UE 100. The UE 100 sends a SIP PRACK 126 and sends a NAS Bearer Resource Allocation Request 156 for each bearer it requires for the application (assume two bearers) to the MME 104 and starts timer T3480 for each.

The MME 104 sends a Bearer Resource Command 158 to the SGW 106 which sends an equivalent message to the PDN GW. The PDN GW 106 interacts with the PCRF 108, which based on its previous interaction with the application function provides the authorization back to the PDN GW106. This interaction takes the form of CCR 160 and CCA 164. Optionally, PCRF 108 can provide an event notification message 162 to P-CSCF 110.

The PDN GW 106 initiates procedure for setting up dedicated GBR bearer(s) by sending message 128 to MME 14, which forwards message 130 to eNB 102. When the eNB 102 receives the bearer setup request(s) 130 (or reservation requests) it determines that there are no available radio bearer available at this time, and determines from the ARP priority level and queuing indicator that the received request(s) should be queued for the next available radio bearer resources. The eNB 102 puts the request(s) in a queue, starts a queue timer (Qt) 132 and preferably notifies the MME 104 that all the dedicated bearer requests for that UE 100 are queued a bearer setup queuing notification message 134.

In a presently preferred embodiment, the default value for the NAS Bearer Resource Allocation Request timer (T3480) in the UE 100 is 8 s. If the eNB 102 queues the reservation requests from the MME 104 for more than 8 seconds the timer will expire and the UE 100 sends a new bearer allocation request. In some embodiments it is desirable to send a NAS status 166 back to the UE 100 from the MME 104 to inform that the bearer request is being queued.

The MME 104 forwards the queuing status 136 to the SGW/PDN-GW 106, and the PDN-GW 106 determines from the action triggers received from the PCRF 108 that it should notify the PCRF 108 if resource requests are queued. It sends the event trigger notification message 138 to the PCRF 108, and the PCRF 108 sends the notification 140 back to the application (P-CSCF) 110. The P-CSCF 110 determines from the preconditions that the terminating user is waiting for resources to be setup in the originating side, thus initiates a SIP 182 message 142 back through the IMS chain to the terminating user.

Before Qt 132 expires, resources are freed and eNB 104 resumes the radio bearer resource setup procedure outlined above with messages 144, 146, 148 and 150. Following successful establishment of all the requested GBR bearer requests, the UE 100 sends a SIP UPDATE message 152 to the P-CSCF 110. The P-CSCF 110 stops sending SIP 182 message 142 and forwards the SIP UPDATE 154 towards the terminating user via the IMS chain. The terminating user is alerted and a SIP 180 is sent to the originating user (not shown).

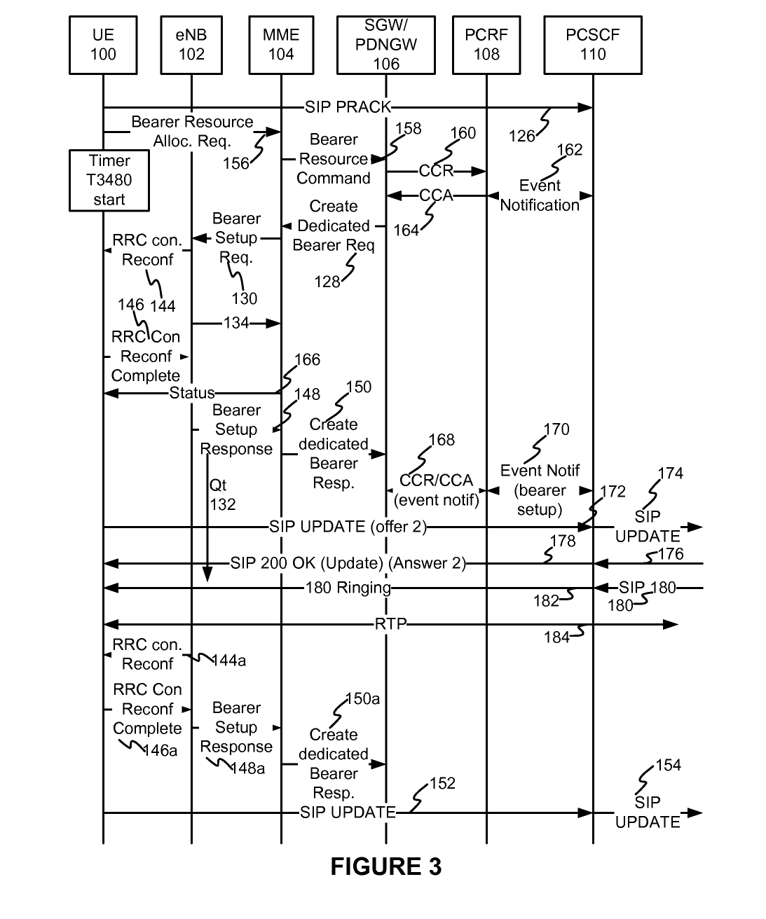

FIG. 3 illustrates the call flow when queuing in the originating eNB arises as a result of a partially successful resource reservation. The UE 100 include in the SDP Offer 112 two media lines (voice and video), with mandatory local precondition for the voice media and optional local precondition for video media. Same conditions as in the call flow of FIG. 1 except that a UE 100 initiates resource reservation procedure when it receives the SIP 183 message containing the preconditions answer.

As before, but omitted from FIG. 3 for clarity and simplicity, When the P-CSCF 110 receives SIP 183 message in response to the SIP INVITE, the SIP 183 will include the preconditions answer as well as the RPH with ets and wps namespace, the later carries the user priority level in its rvalue as authorized by the application.

The P-CSCF 110 interacts with the PCRF 108. The PCRF 108 sends an acknowledgement back to the P-CSCF 110 and the P-CSCF 110 forwards the SIP 183 answer message to the UE 100. The UE 100 sends a SIP PRACK 126 and sends a NAS Bearer Resource Allocation Request 156 for each bearer it requires for the application (assume two bearers) to the MME 104 and starts timer T3480 for each requests (it seems that the NAS message includes information only for one bearer).

The MME 104 sends a Bearer Request Command 158 to the SGW 106 which sends an equivalent message to the PDN GW. The PDN GW 106 interacts with the PCRF 108, which based on its previous interaction with the application function provides the authorization back to the PDN GW 106. As before, this interaction takes the form of CCR 160 and CCA 164, with PCRF 108 optionally sending Event Notification 162 as before.

The PDN GW 106 initiates the procedure for setting up two dedicated GBR bearer(s) by sending the Create Dedicated Bearer Request 128 to MME 104. When the eNB 102 receives the bearer setup request(s) 130 from MME 104 it determines that there are sufficient resources to setup only one of the GBR radio bearer, and determines from the ARP priority level and queuing indicator the request that should be queued for the next available radio bearer. The eNB 102 establishes one of the radio bearers using message 144, puts the additional request in a queue, starts a queue timer (Qt) 132 and notifies the MME 104 that one of the bearer requests is queued.

In a presently preferred embodiment, the default value for the NAS Bearer Resource Allocation Request timer T3480 in the UE is 8 s. If the eNB 102 queues the second bearer setup request for more than 8 seconds, the timer will expire and the UE 100 will send a new request. It may, in some embodiments, be desirable to send a NAS status message 166 back to the UE 100 from the MME 104 to inform that the second bearer request status is being queued.

Because one of the bearer requests is queued and only one of the media bearer is established, the MME 104 determines based on the event trigger received from the SGW 106 if queuing notification should be sent from MME 104 to SGW 106. The event trigger may indicate queuing notification if all or a required bearer reservation request is queued. The following alternatives may be possible:
1. If the UE 100 has indicated in the SDP offer (in the INVITE) that local preconditions for all media streams must be met, the P-CSCF 110 would include a queuing action trigger over the Rx interface when it interacts with the P-CSCF 110. Subsequently, if only one media bearer has been setup, while the other media bearer request is queued, then the MME 104 forwards the queuing status to the SGW/PDN-GW 106, and the PDN-GW 106 determines from the action triggers that it should notify the PCRF 108 (using message 168). The PCRF 108 sends the notification back to the application P-CSCF 110 through notification 170. The P-CSCF 110 initiates a SIP 182 message (not shown) back through the IMS chain to the terminating user.
2. As shown in FIG. 3, if the UE 100 includes mandatory precondition for one media stream (e.g., voice), but includes an optional precondition (or normal SDP) for the another media (e.g., video), the P-CSCF 110 would include over the Rx interface a queuing action trigger only for the media stream that is mandated in the precondition. Subsequently, if the media bearer request 130 associated to the optional precondition is queued, the MME 104 will not forward the queuing notification uplink to the SGW 106 as would be indicated by the action trigger previously received from the SGW 106.

As shown in FIG. 3, the eNB 102 successfully established the required radio bearer (i.e., as required by the mandatory precondition and as indicated by message 146). The UE 100 sends a SIP UPDATE message 172 which includes a new SDP offer that does not include the video media line to the P-CSCF 110. The P-CSCF 110 forwards SIP UPDATE 174 to the terminating user through the IMS chain. The terminating user sends a 200 OK message 176 for the UPDATE that includes an SDP answer, followed by a SIP 180 message 180 indicating that the terminating user has been alerted. A SIP 200 OK message 178 is sent from the terminating end as is a SIP 180 message 182. An RTP session 184 can be established and voice packets can be exchanged over the RTP bearer.

Before Qt 132 expires in the eNB 102, resources are freed and eNB 102 resumes the radio bearer resource setup procedure for the second bearer using message 144a. Following successful establishment of the second GBR bearer as indicated by the transmission of messages 146a, 148a and 150a, the UE 100 sends a SIP UPDATE message 152 with a new SDP offer to the P-CSCF 110. The P-CSCF 110 forwards the UPDATE message 154 towards the terminating user via the IMS chain. If the terminating user accepts the SDP offer, it responds with a 200 OK (not shown) which includes an SDP answer that may indicate that the resources are ready at the terminating end, and starts a second RTP video media stream.

In some situations, the UE 100 can give up on the video bearer if the important voice bearer is established and the network indicates that the video bearer request is queued in the network. The UE 100 may send a NAS Resource cancellation/release request which will then inform the eNB 102 to remove the request from the queue.

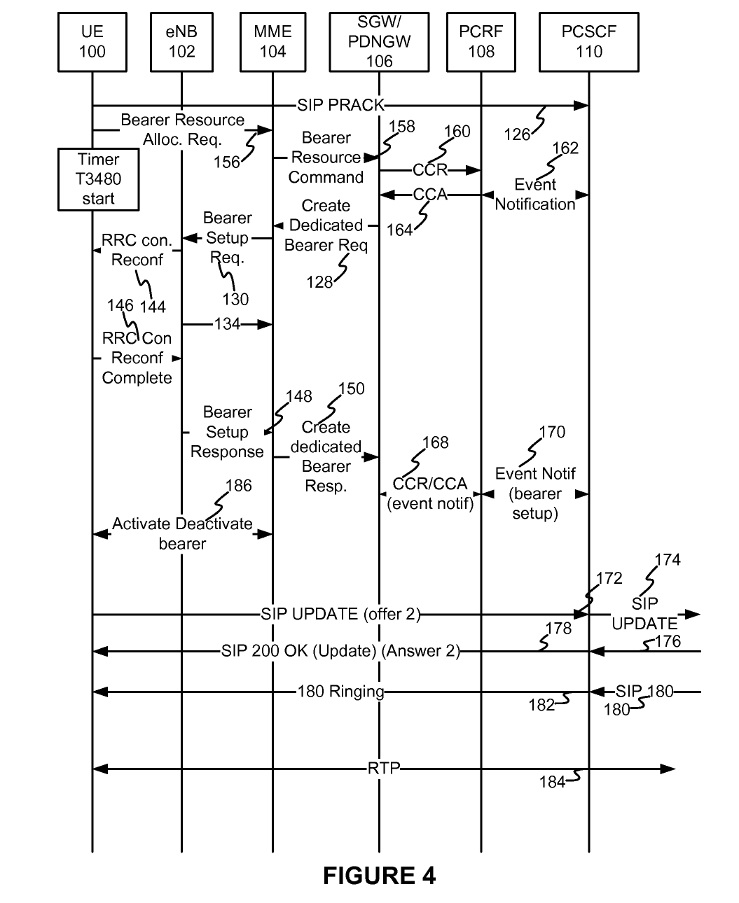

Another alternative could be that media that are associated to a precondition tagged as optional or media included in normal SDP will not require queuing. This can require signaling by the P-CSCF 110 to the PCRF 108 indicating the queuing requirement per media based on the precondition strength or on whether preconditions are used for a media line. This alternative is illustrated in the high level diagram of FIG. 4.

The terminating UE 100 include in the SDP Answer (not shown) two media lines (voice and video), with mandatory local precondition for both media. The UE 100 will only send a SIP 180 towards the originating end until all local resources are successfully established and the preconditions in the originating end are met.

SIP 182 may be sent from the P-CSCF after it receives a SIP UPDATE from the originating UE 100 or after it receiving the queuing event notification from the PCRF 110.

The call flow follows the same process outlined in FIG. 3, where identical calls are referred to using the same reference numerals. The processes are the same until message 170. Prior to sending SIP UPDATE (offer 2) message 172, UE 100 and MME 104 exchange activation/deactivation bearer messages 186, allowing for the request for the unavailable channel to be dropped.

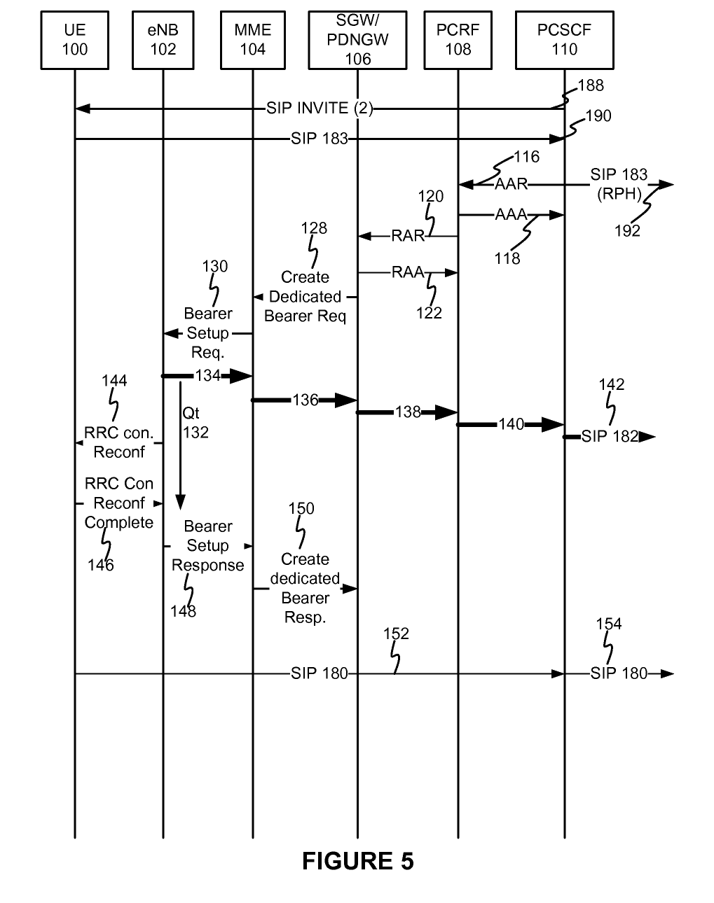

FIG. 5 illustrates a message flow for the reservation of two dedicated GBR bearers, and network initiated reservation is used. However, there are no available radio resource bearers in the terminating eNB 102. The terminating eNB 102 is able to queue the dedicated bearer resource requests from the MME 104 if a queuing indication is included in the bearer request messages. The queuing indicator can be embedded in the ARP information element.

As this call flow is network initiated, SIP INVITE (2) message 188 is sent from P-CSCF 110 to UE 100. When the P-CSCF 100 receives SIP 183 message 190 from the terminating UE 100 in response to the SIP INVITE message 188, the SIP 183 message 190 will include the preconditions answer as well as the RPH with ets and wps namespace, the later carries the orgnating user priority level in its rvalue as authorized by the application in the originating network.

The P-CSCF 110 interacts with the PCRF 108 using AAR 116. The PCRF sends an acknowledgement AAA 118 back to the P-CSCF 110 and the P-CSCF 110 forwards the SIP 183 message 192 to the originating UE through the IMS chain. The PCRF 108 performs the QoS mapping and interacts with the PDN GW 106 over Gx interface for resource reservation using messages RAR 120 and RAA 122. The PCRF 108 includes the PCC rules which include the QoS information (ARP, QCI, GBR, MBR) to modify or create one or more dedicated GBR bearers. The ARP would include the queuing indicator if the application and/or the user subscription indicate that such priority mechanism should be applied in the event of congestion.

The PDN GW 106 initiates procedure for setting up dedicated GBR bearer(s) by sending create dedicated bearer request 128. When the eNB 102 receives the bearer setup request(s) 130 it determines that there are no available radio bearer available at this time, and determines from the ARP priority level and queuing indicator that all the received request(s) should be queued for the next available radio bearer resources. The eNB puts the request(s) in a queue, starts a queue timer (Qt) 132 and then optionally notifies the MME 104 that all bearer requests are queued using message 134.

The MME 104 forwards the queuing status 136 to the SGW/PDN-GW 106, and the PDN-GW 106 determines from the action triggers received from the PCRF 108 that it should notify the PCRF 108 if resource requests are queued. It sends the event trigger notification message 138 to the PCRF 108, and the PCRF 108 sends the notification back to the application (P-CSCF) 110 as message 142. The P-CSCF 110 determines from the preconditions if the originating user is waiting for resources to be setup in the terminating side, if so, it initiates a SIP 182 message 142 back through the IMS chain to the originating user.

Before Qt 132 expires, resources are freed and eNB 102 can resume the radio bearer resource setup procedure using messages 144, 146, 148 and 150 as described above. Following successful establishment of the GBR bearers, the UE 100 sends a SIP 180 message 152 to the P-CSCF 110. The P-CSCF 110 forwards the SIP 180 message 154 towards the originating user via the IMS chain.

By providing a mechanism that informs nodes awaiting a session initialization that queuing has been undertaken, and resources should be reserved, in conjunction with a defined timer to prevent indefinite queuing, the system and method of the present invention allow for a smooth and transparent support of queuing for resources in the packet based access network when resources are requested by an application, without causing disruption in the end-to-end session establishment or disruption to end user experience.

In the present invention, the eNB is the node that determines whether or not queuing is required. The eNB of the present invention is thus able to determine resource availability, and can generate queuing notification requests that are propagated into the IMS chain towards the P-CSCF. One skilled in the art will appreciate that this can be achieved through the use of a resource availability engine that can either determine resource availability on its own or obtain the availability information from other network elements. Based on the availability, a decision to queue the requests can be made, and a timer started. Queuing can then trigger a messaging interface to issue queuing notification messages to be sent to upstream nodes. Those skilled in the art will appreciate that this can be achieved in a number of different ways including the use of dedicated hardware or software controlled general purpose computing platforms.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of queuing emergency telecommunication service requests in a packet based telephony network node comprising:
receiving an indication that resources required for a requested emergency telecommunication service are not presently available;
queuing the request;
reserving available resources for the requested service; and
issuing a notification to the node from which the service request was received that queuing has been undertaken.

2. The method of claim 1 wherein the packet based telephony network node is an evolved-UTRAN node B (eNB).

3. The method of claim 2 wherein the step of receiving includes determining that user equipment cannot be reached due to network congestion.

4. The method of claim 2 further including the step of initializing a timer.

5. The method of claim 4 further including the step of cancelling the reservation of the available resources upon expiry of the timer.

6. The method of claim 2 further including the step of initiating the requested service upon acquiring sufficient reserved available resources.

7. The method of claim 1 wherein the requested service includes a request for a plurality of services.

8. The method of claim 8 wherein the received indication indicates that sufficient resources are available for one of the requested plurality of services.

9. The method of claim 8 further including the step of initializing one of the requested plurality of services using the available resources and wherein the step of queuing includes queuing the services in the plurality of services not initialized.

10. The method of claim 8 further including initializing a timer and upon expiry of the timer dropping queued services in the plurality of services not initialized.

11. The method of claim 1 wherein the node is a mobility management entity (MME) and the step of receiving includes receiving a message from an eNB that the service request has been queued.

12. The method of claim 1 wherein the node is a signaling gateway (SGW) and the step of receiving includes receiving a message from a mobility management entity that the service request has been queued.

13. The method of claim 1 wherein the node is a policy and charging rule function (PCRF) and the step of receiving includes receiving a message from a SGW that the service request has been queued.

14. The method of claim 1 wherein the node is a Proxy Call Session Control Function and the step of receiving includes receiving a message from a PCRF that the service request has been queued.

15. A node for use in a packet based telephony network, the node comprising:
a resource availability engine for determining the availability of network resources;
a request interface for receiving a request for emergency telecommunication services;
a processor operatively connected to the resource availability engine and the request interface for determining in accordance with the engine and the request interface that a requested service should be queued; and
a messaging interface for sending a message to the node from which a request for emergency telecommunication services is received indicating that the request has been queued upon determination by the processor.

16. The node of claim 15 wherein the node is an evolved-UTRAN Node B (eNB).

17. The node of claim 16 wherein the resource availability engine determines that resources are unavailable by receiving an indication of lack of resources from another node.

18. The node of claim 15 wherein the node is a mobility management entity (MME) and the resource availability engine determines that resources are unavailable by receiving an indication of lack of resources from an eNB.

19. The node of claim 15 wherein the node is a signaling Gateway (SGW) and the resource availability engine determines that resources are unavailable by receiving an indication of lack of resources from an MME.

20. The node of claim 15 wherein the node is a proxy call session control function (P-CSCF) and the resource availability engine determines that resources are unavailable by receiving an indication of lack of resources from a policy and charging function.
